(19) United States
(12) Patent Application Publication
(10) Pub. No.: US 2008/0065649 A1
(43) Pub. Date: Mar. 13, 2008

(54) Method of associating independently-provided content with webpages

(76) Inventor: Barry Smiler, Albany, CA (US)

Correspondence Address: DERGOSITS & NOAH LLP, FOUR EMBARCADERO CENTER, SUITE 1450, SAN FRANCISCO, CA, 94111, US

(21) Appl. No.: 11/899,916

(22) Filed: Sep. 6, 2007

Related U.S. Application Data
(60) Provisional application No. 60/843,220, filed on Sep. 8, 2006.

(51) Int. Cl. G06F 17/30

(52) U.S. Cl. 707/10; 707/E17.001

(57) ABSTRACT

The inventive system includes a content server that communicates with access programs on a plurality of client computers. The access programs monitor the URIs input into the web browser program on each computer. When a URI is detected, or when certain housekeeping tasks must be performed, the access program transmits a request for content referencing that URI, or that housekeeping task, to the server. The server searches a data store such as a database and returns relevant data to the access program, which data is displayed on the client computer. In addition to viewing existing content, the user can submit new content, which content becomes part of the data saved in the database. When the user switches to a new website or webpage the process is repeated and data related to the new website or web page's URI is displayed.

### CROSS REFERENCE TO RELATED PATENT APPLICATIONS

The present application claims priority to U.S. Provisional Patent Application Ser. No. 60/843,220 which was filed Sep. 8, 2006.

### BACKGROUND

There are various methods for displaying user-supplied content and other content while viewing webpages accessed through the internet. For example, there are websites that include descriptions of goods, services or information that also include a section where a user can post content or feedback. These user content sections can include consumer ratings for a product or service. The ratings can include a quantitative rating such as stars or a score and possibly user-supplied text comments.

A potential problem with these user posted content sections is that they are integrated into the website in question and while there might not be any visible evidence of editorial control, it is always possible that any content posted on such a website might have been edited by the website's management. For example, a website's management might delete negative content that has been posted about the goods or services associated with the website, or content that recommend a competitor's goods or services. Consumers may be highly suspicious of such websites.

In addition to websites having integrated user posting sections, there are also independent third party content websites at different locations on the internet, that is, not at the vendor's own website. Typically, these independent websites are not associated with any provider's goods or services. Users of such websites may be able to read ratings, reviews, and other content posted by other users, and post their own ratings, reviews, and other content. Such websites might focus on a specific topic, for example restaurants, movies, a specific type of product, certain service providers, teachers, etc. Over time a large amount of user content can be posted on such a website, giving a reader access to the collective experience of all the posters. This information can be useful to other users in making choices such as purchasing decisions.

A problem with such a website is that the user must independently know of it and, after locating it, then search through its stored data for information on the goods, services or merchants of interest. For example, a user looking for information on a particular restaurant might go to that restaurant's website to look at its menu, location and phone number. That website may even include supposedly unbiased testimonials from customers. But there is no way to determine if these testimonials have actually been posted by the management and are truly unbiased. To determine if the restaurant is actually any good, the user must locate, and then go to, an appropriate independent review website or other information source such as a printed book of reviews, look up that restaurant, and read its reviews. This task can be problematic when there are several restarants with the same or similar name, if the exact spelling or location is not known by the user, or in other situations. In any of these situations a user could easily base a decision on an inaccurate or misidentified review.

Thus, the task of finding useful reviews of goods and services can be time consuming and is often technically daunting. Also, the available materials may be limited to posts by those with the special motivation and expertise to provide them. For example, the seller of a product may be the only one with the motivation to post positive reviews. These, of course, may not be entirely accurate.

There are also communication website systems that allow users who are simultaneously viewing the same website to communicate with each other via chatroom-style real time messaging. These systems require the user to view the website of interest redirected through the communication website server (that is, not through direct contact with the actual website of interest as is usually done). This is done by going to the communications website and providing to it the uniform resource identifier (URI) of the website of interest through the browser program. The communications website displays a copy of the website of interest with a separate communications screen which allows those users who are simultaneously viewing the same website to communicate by transmitting and receiving text messages.

One problem with these systems is that they do not store any of the content that is posted in any user-accessible manner, making it impossible for a user to post content that remains publicly available for any significant period of time. Thus, once the users leave the communications website session, all information that has been posted is lost. Another problem is that the website of interest might be displayed in a modified form. A third problem is regarding privacy and security, in that all interaction between the user and the website of interest (for example login and password information or account numbers) goes through the communications website, and since all user keystrokes directed to the website of interest can be detected by the communications website, a user's security on the website of interest may be compromised.

What is needed is an easier, more secure, and more automated method for posting, storing and accessing content information that is associated with vendors, goods, or service providers. The improved method should be more easily accessible to other users who view the posted content. It should be accessible in a more obvious and transparent way. It should also make the process of posting and accessing content available to a larger number of people than any currently available processes do.

### SUMMARY OF THE INVENTION

The invention is a system that provides users with a forum for reading and posting content that is visibly associated with specific websites, yet whereby the content remains entirely independent from the websites themselves. The inventive system works with web browser programs and can automatically display independent content data that is associated with the displayed website and its associated webpages. When a user goes to a website, the inventive system's independent content is displayed on an independent screen. This screen may be within the browser window itself, or it may be in a separate window generated by the inventive system. When the user goes to another website, the inventive system's screen is automatically updated to reflect the inventive system's independent content related to the new website or new webpage.

Each website has a specific uniform resource identifier (URI) which uniquely identifies that website. A URI can be submitted in various ways. While the normal method is performed by the user submitting a new URI to the web browser, various other methods are possible. The URI may be switched in response to various controls or inputs including: auto forwarding, redirects, links, etc. The inventive system will function equally well with any method for submitting a URI to a web browser program.

In an embodiment, the inventive system's logical components can include a server, a data store, and one or more access programs each running on a client computer. The server and/or data store may be on the same computer as the access program or elsewhere, and they may be implemented as part of the access program or separately.

The access program is the component that interacts with a client computer's web browser. The access program can be installed through a recordable medium or in any other manner. As the user moves from website to website or webpage, the access program detects the URIs of those websites and webpages, each in turn. When a new URI is detected, and in certain other cases when requested by the user, the access program contacts the inventive system's server and requests whatever relevant content the server has associated with that request. Typically, though not necessarily, this server will be at another location on the internet. The server searches a data store (typically a database) for relevant content. In general, the request will be a search for content which the server has associated with that URI. The request can also be a search of the data store for content that is not restricted to content associated with a single URI. The server transmits this content back to the access program on the requesting client computer. The access program then displays the supplied content in a window on the client computer. When a new request is made (typically, when a new URI is provided to the web browser and a different website or webpage is displayed in the web browser), the components of the inventive system repeat this process and automatically display the new content that the server has provided.

In addition to automatically providing existing content that is germane to the website or webpage currently being viewed, the inventive system also allows users to post new content. In an embodiment, when a user wishes to post content, the user actuates a “new comment” function of the access program which opens a content input screen so the user can input the content into that screen. Some other information may also be required to post content, such as the user's name (or “handle”, i.e. alias) and an e-mail address. An access code such as a CAPTCHA code may also be required to limit spam or other unauthorized use of the system. Once the required information is provided, the user can post the content. The posted content is stored in the inventive system's data store with any other supplied data that has previously been associated with the URI. Once posted, the content can be viewed by other users of the system who go to that webpage or website and have the access program. In some embodiments, the user may be required to have appropriate access permission to view the posted content.

On each client computer, the inventive system's access program window can be separate from the browser window or it can be integrated into the browser window. If the access program window is separate from the browser window, the user can control the size and location of each window and the inventive system may remember the size and location of the access window(s) so that they are displayed in the same area when the access program is next run. In another embodiment, the access program may resize the browser window so that the access program window(s) and the browser window(s) will appropriately fit on the computer display.

Although the access program monitors the currently-displayed webpage and website, and controls the access program window that displays content associated with that webpage and website, nothing in the inventive system modifies any materials or information displayed by that webpage or website in the browser window. The inventive system also does not redirect the browser to display the webpage or website by way of any third party server, i.e., a server other than that of the webpage or website itself. Thus, the browser will display the webpage or website in the same manner, and with the same level of safety and security as would exist without the use of the inventive system.

The inventive system is particularly useful because almost all vendors, goods and services have websites. Since the access program functions by detecting URIs for websites, the inventive system can automatically and easily provide the precisely relevant content that is associated with any vendors, goods and services that have websites. The inventive system also functions independently of all associated websites. This separation allows users to post content to an independent forum related to a specific website, without the possibility of negative comments being deleted from a website's “comments” or “review” section (or similar) by the management of that website.

The inventive system is also much more convenient than using a third party commentary web site located elsewhere on the internet. As discussed, in order to access relevant information on such a third party website, the user must first find and access the website and then search for references to the desired products, reviews, comments, or other content. In contrast, the inventive system provides the desired content more easily and accurately by automatically detecting the URI of the currently-displayed webpage or website and thereby displaying precisely the relevant content data that has been posted in association with that URI by other users. Thus, the inventive system can provide independent content related to each and every website without any requirements other than the use of the access program. No coordination is required from the management of that website, no modification of that website's code or design is necessary, and every website in the world automatically has such an independent forum.

In addition to websites set up directly by providers of products or services that describe their offerings, the products or services can also be described on websites from other sources such as electronic commerce merchants or product distributors. The inventive system can provide distinct content for any webpage in a website, thus content can be posted and viewed through the inventive system relating to websites of vendors, product providers, distributors or any other type of website.

The posted content that is to be associated with corresponding URIs can also cover a wide range of topics. For example, a product website can have associated content that includes information regarding the product's quality, usefulness, usage tips and advice, return policy, manufacturer warranty, customer service, competing or similar products, etc.

In an embodiment, the inventive system allows users to post content in many forms, not just text content. In this disclosure, “content” is intended to represent all data in any form including audio, images, video, text, numbers, symbols, etc. It can include any types of communicated data including ratings, reviews, discussions, opinions, stories, records, calculations, theories, fact, fiction, etc.

The inventive system is intended to be used to provide useful content for the inventive system's users. For example, a user may be interested in a particular restaurant. The user may input the URI of the restaurant, since many restaurants have websites that disclose menus, directions and phone numbers. When the access program detects the URI, it transmits the URI to the inventive system's server which searches the data store for content associated with that URI. The content data stored on the inventive system that is associated with the restaurant website's URI in this example can include further information, posted by other users, regarding such things as food quality, service, atmosphere, price, difficulty of parking, cuisine, etc. This content is transmitted back to the user's computer and displayed. Content posted to the inventive system is independent of the management of that website, yet that content is visible to a user of the inventive system whenever that website is displayed. Thus, the inventive system provides a mechanism for viewers of that website to share independent comments and other content which may be related to that website's offerings.

In yet another example, websites for services such as auto repair shops similarly describe the types of services provided, address, phone number, and similar information. When a user goes to an auto service URI, the access program transmits the URI to the server and the data store is searched. The inventive system's independent content associated with the auto repair website's URI might include such further information as repair quality, perceived value, service, warranty experience, recommendations, opinions, etc. It could also include other information and content. Again, this content is automatically transmitted back to the user's computer and displayed.

Most websites have a main webpage and one or more subpages. In such a case, each page will have an individual unique URI and by using the inventive system each such individual page can have separate associated independent content. This can be particularly useful when browsing through an online catalog of goods, since using the inventive system can cause each product or product group's individual subpage to have its own associated content. In such a case, as the user browses through the individual product pages, the inventive system's data window will change accordingly so that unique content can be provided for each individual page of the website.

Although the system has been described as sending the URI to the content server to obtain the content data, it is also possible to use a representation of the URI rather than the literal URI. Similarly, the inventive system's database may have data stored according to a representation of the URI rather than the literal URI. For example, the representation of the URI may be a normalized version of the URI input to the browser. Thus, in this context, “URI” is intended to mean any specific representation of the URI as well as the literal URI. In this context, “URI” is intended to also include “URI” and “URN” as these terms are often used interchangeably. Further, “URI” is intended to include any parameters transmitted with the base URI. The parameters transmitted with the URI may be used by the inventive system to distinguish the webpage being displayed in the web browser and therefore the content to be displayed by the inventive system. The inventive system can store and retrieve content data based upon both the base URI and parameter data.

Websites may consist of predefined information known as static webpages or the web server may construct the webpage when it is requested, known as dynamic webpages. The inventive system functions equally well with static or dynamic webpages. Its processing will be transparent to the user so that both static and dynamic webpages will appear to the user to be processed in the same manner.

In an embodiment, the access program offers multiple “channels” that each represent substreams of the cumulative content data associated with a URI. This allows a user to select a channel to access that portion of the cumulative content that is most relevant to the user. The different channels may each target specific groups of users, or segment the data using other criteria. In an embodiment, different channels can focus on different user groups, and can be divided by characteristics such as gender, age, interest group, etc. Alternatively, the channels can segment the data in other ways, for example to provide different types of communications including audio, video, VOIP (voice over IP), interactive games, etc. Controls provided by the inventive system could allow the user the option of selecting any desired channel. In an embodiment, the inventive system can also provide “private channels” that have restricted user access wherein the user must provide a password and/or other information in order to access the private channel.

While the inventive system has been described as being a content posting system that allows users to view and read static content that was posted in the past, it is also possible to use the inventive system for real time communications. In an embodiment, the inventive system can provide a direct real time communications link between two or more users, for example users who are simultaneously viewing the same website or webpage. This real time communications feature can be useful when using interactive or event coverage websites. Rather than merely observing the events, the users can communicate through the inventive system via “instant messaging”, VOIP (voice over IP) or other audio mechanisms, video, or other means. This capability could allow users to share the experience while the event is taking place. Event coverage could include sporting events, breaking news, online games, financial news regarding specific stocks, mutual funds, etc.

The inventive system can also provide various controls that allow the users to post content and alter the user's preferred display. For example, the access program display can be set up as a window adjacent to the web browser window. Alternatively, the inventive system's window may be controlled by a button, tab, or other control in the browser window or elsewhere which allows the inventive system's display to be toggled on and off. Various other visual features of the inventive system can be controlled in similar ways.

### BRIEF DESCRIPTION OF THE DRAWINGS

The invention will be more fully understood by reference to the following detailed description of the invention in conjunction with the drawings:

FIG. 1 is a flowchart of the inventive system's overall operation;

FIG. 2 is a flowchart of the inventive system's server operation;

FIG. 3 is a screenshot of an embodiment of the inventive system's main screen in the access program window, and a browser window;

FIG. 4 is a screenshot of an embodiment of the inventive system's new comment/content screen in the access program window, and a browser window;

FIG. 5 is a screenshot of an embodiment of the inventive system's options screen in the access program window;

FIG. 6 is a screenshot of an embodiment of the inventive system's sponsored channel feature, displayed towards the top of the access program window;

FIG. 7 is a screenshot of an embodiment of the inventive system's search screen in the access program window;

FIG. 8 is a screenshot of an embodiment of the inventive system's information screen, displayed in the access program window;

FIG. 9 illustrates an embodiment of the inventive system's embodiment as a client/server computer network; and

FIG. 10 illustrates an embodiment of the inventive system's embodiment as a peer to peer network.

### DETAILED DESCRIPTION

The inventive system automatically provides independent user content sharing capability to viewers of any website or webpage in the world, without requiring any modification of, coordination with, or cooperation from such website. When the inventive system detects that the user is viewing a webpage, it can automatically display independently posted content associated with that webpage.

The content it displays can include comments, observations, reviews, statements, analysis, ratings, etc., in any type of recordable format including text, video, audio, images, Braille, etc. The content may be static or interactive, and may include buttons or other controls or components that can respond to input from the user, or from the computing environment, or from elsewhere. The content may have originated from the system's users, from its management, from its advertisers, or from some other source. Any displayed screen may include any number of these elements, which may be arranged in any order. All of these different types of information are herein referred to simply as “content.” This content could be accessible to the users through the computer screen, speakers, displays or any other type of computer output device.

The inventive system can be configured in various ways. The primary components can include a data store, a server, and an access program running on a plurality of client computers. The data store is accessible to the server and the server is in communication with one or more access programs each running on a client computer. While the preferred embodiment includes the server, data store and access program, two or more of these logical components can be combined instead of being independently implemented components. For example, the data store can exist as a subcomponent of the server or access program. In yet another embodiment, the server and data store can both exist on a client computer with the client and server logically different. For clarity, the inventive system will primarily describe its server, data store and access program as separate and distinct system components. However, it is intended that these descriptions not limit the invention to this structure.

In an embodiment, the inventive system includes: a content service access program (the “access program”) running on one or more of the client computers as a standalone or installable set of instructions that function with another program such as a web browser. The access program may be implemented as one standalone executable program, or a suite of standalone executable programs, or one or more browser extensions not directly executable, or a combination of these. The content service server (the “server”) can be one or more physical or logical devices that communicate(s) with the access program(s). The server can communicate with the access programs, for example through a network such as the internet or an intranet. The server has access to a data store such as a database or a set of databases (the “database”) containing content data (including metadata) that has previously been provided to the server by users who have posted the content through the access program(s). In embodiments where the data store is implemented as a set of databases, the databases may be physically separated but may function as a single logical data storage device with a single point of contact for accessing the content data.

The access program works with the client computers' web browser program(s) and detects the URI that is input into the browser. When the access program detects the URI, the access program transmits the URI to the server as part of a request for content associated with the URI. The server searches the data store for content that has been associated with the URI. A subset of the cumulative data store content that is associated with the URI is extracted from the data store by the server and sent back to the access program on the client computer that requested the content information. The content returned to the access program on that client computer is then displayed through the access program in a window or designated display space (the “window” or “access program's window”). The displayed content will depend on which webpage is currently active in the web browser, and on other factors such as the user's chosen display settings.

In this disclosure, “URI” is intended to mean a URL, a URI, a URN, or any other identification of a website, webpage, or other network-based resource. Thus, references to a URL, URN, URI, or similar term should be interpreted as meaning any clear identification of the website, webpage, or other such resource.

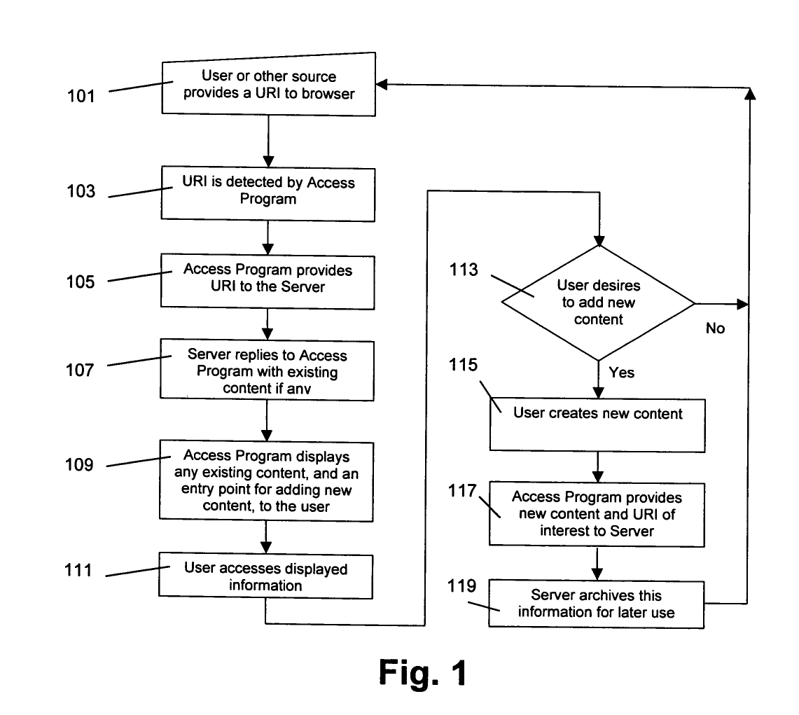

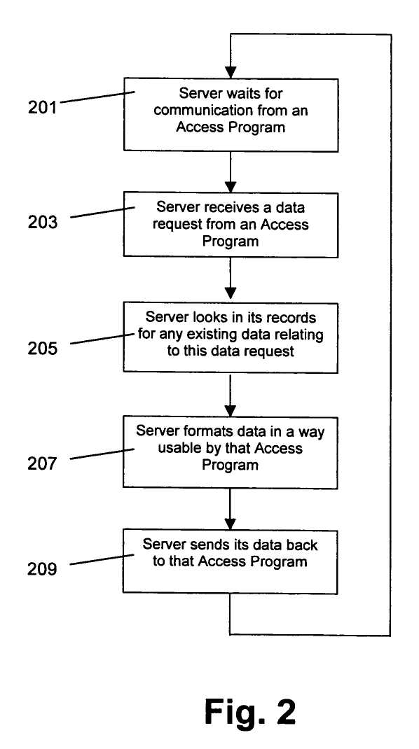

The operation of an embodiment of the inventive system is described with reference to FIG. 1. At step 101, the user or other source inputs a URI into an internet web browser or similar program. In addition to detecting the URI input into the web browser by the user, the system will also detect the use of links or other means of providing a URI. For example, if a user is viewing an advertisement in the web browser (not in the inventive system) and clicks on the advertisement's image or link, the web browser is directed to a location, such as a webpage, that has been selected by the advertiser. The web browser then displays the data that the advertiser has specified, such as text, images, etc. The inventive system will detect the linked URI, as well as the URIs of any other websites or other such resources as they are displayed by the web browser on the user's computer. The system will also detect URIs that may not be selected by the user such as URIs for pop-up ads, auto forwarding, redirects, links, etc. The access program detects all such URIs 103 and transmits a request to the server 105 for content data related to the detected URI. The server searches for and obtains the relevant content data from the inventive system's data store (for details, see FIG. 2). The server then replies to the access program which requested the data and transmits the retrieved content data back to that access program 107.

The server may format the retrieved content data, or it may be left in a pre-formatted state such that the access program can do any necessary formatting. Alternatively, the requesting access program may transmit the format requirements to the server, or the server may store the format requirements for each requesting computer or for all computers generally. Thus, in different embodiments the formatting can be performed by the server or by the requesting computer.

When the access program requests data related to a specific URI and there is no archived content data specifically associated with that URI, the response to the request for data might be an empty page, or the response might be a non-empty page with some content data but no user-supplied content. If the system provides ad space, the response may have one or more advertisements. The response might also have other material such as system information or page design layout information. Whatever the response from the server, the content transmitted to the access program is displayed on the client computer 109.

The content can be displayed in various ways. A single access window may be displayed for the active browser window or tab, or multiple access windows may exist for each active or non-active browser window or tab on the computer. In an embodiment, the access program's window is opened on the computer screen adjacent to, but distinct from, the browser window. In another embodiment, the access program's window(s) can be integrated into a portion of the web browser's own window. In yet another embodiment, the access program displays a button or other control mechanism on a menu or tool bar or elsewhere, and the access program's window can be hidden or accessed by the user actuating said button or control, thus allowing the user to toggle between a displayed and hidden window. In yet another embodiment, a button or other control can change color or shape to indicate to the user that content associated with a URI is available.

The access program can also allow users to add new content through the access program window (the “access window”). In an embodiment, the screen displayed in the access window may have a “new comment” button. By clicking on the “new comment” button the access window may display an input area in which the user can create new content to be associated by the invention's server with the URI of the webpage currently displayed by the web browser 115. The user can then press a “submit comment” button that causes the newly created content to be transmitted to the server. The new content is received by the server 117 and saved in the data store where it is associated with the URI 119. Alternatively, if the user decides not to submit the new content, the “cancel” button can be clicked to cancel the submission. If the new submission is cancelled, the system will return to step 101 and will retrieve and display the content for the currently detected URI, as described above.

Although the controls are herein described as “buttons”, various other controls or mechanisms can be used to perform the button pressing task including: tabs, bars, hypertext, and other kinds of interface elements.

The user may visit multiple webpages or websites and the inventive system will respond by providing the stored content associated with each of the webpages or websites. While at each of the webpages or websites, the user can read, see, hear, and otherwise gain access to the archived content which the inventive system has related to that webpage or website's URI. When the user views a new webpage, the inventive system will update the access program's window so that the displayed content is that content associated with the new webpage's URI. Whenever the URI in the browser changes 101, the access program detects the new URI 103 and sends that URI to the server 105. The server obtains the appropriate subset of the cumulative data in the data store that is associated with the new URI and transmits this content data back to the content requesting access program on the client computer 107. The newly supplied content data replaces the old content data and is displayed in the access program's window 109.

In an embodiment, a single access program window will exist for all browser windows on a given client computer and its window will be updated to reflect the most recently active website that was displayed in any browser window or tab on that computer. In another embodiment, a different access program window will exist for each open browser window and/or tab on a given client computer. The content displayed in the access window(s) will normally change automatically in response to the URI of the browser's most recently displayed website. A possible exception to this automatic switching can occur if a user is in the process of submitting content. In this alternative embodiment the “new comment” screen may not be removed or updated to reflect the newly-displayed website until the user has either submitted the new content or cancelled the operation as described above, however this embodiment is not preferred. As another possible alternative, in addition to keeping the previously-opened access window on the “new comment” screen, an additional access program window reflecting the system's data relating to the new URI may open, however this is also not the preferred embodiment.

When the user closes a browser window, the access program can also automatically close the access window. As an alternative embodiment, the access window will stay open if the user is in the process of submitting new content. Thus, while it may be preferable to only have a single access program window open at one time, various operating characteristics are possible. In an embodiment, the inventive system has controls that give the user the option of configuring the access program to open or close one or more of these windows as desired.

FIG. 2 is a flowchart of possible process steps that can be performed by the invention's server. In this embodiment, the server waits for a request from any computer which is currently running the access program 201. This request could be for content data related to a particular URI, or it could be for metadata such as a search page, options page, or information page. When the server receives any such request from an access program 203, the server then searches the inventive system's data store for any relevant data which can be used to create a response to the request. For example the server may obtain content data associated with the URI, or data relating to the metadata request 205. If relevant content data is found, the server selects an appropriate subset of the cumulative content of the data store and formats the data as the access program requires 207. The server then transmits the formatted data to the access program that requested the content data 209. Once the requested content data is delivered to the access program, the server then resumes waiting for another request from any of the access programs 201.

Note that at step 203, the server may receive a request from an access program for data other than content relating to a particular URI. For example, the server may receive a request for an appropriately formatted search screen or “new comment” data entry screen. In such a case, the server will perform step 205 by generating such metadata using information in the invention's data store. This metadata will then be formatted in a way usable to the requesting access program 207, and supplied to the requesting access program 209.

As discussed above, when the server receives a request for content from an access program, the URI included with such a request may include parameters. In such a case the inventive system can search and retrieve the information associated with both the base URI and the parameter information. In addition to using the parameter information to store and retrieve content data, it is also possible for the inventive system to use the parameter data for other purposes. The parameter information can represent various things. Thus, the inventive system must be able to properly interpret the meaning of the parameter information. For example, internet search engine websites often specify search terms in the parameter information in their displayed URIs when performing searches. In an embodiment, the inventive system can detect when a search engine is being used and use the parameter information in deciding what subset of content stored in the data store to provide to the access program. For example, the system can determine that the user is searching for goods or services if the base URI is associated with an internet search engine website and the parameter information relates to certain goods or services. If these conditions are met, the inventive system could obtain and transmit information about, or advertisements for, related goods or services to the client computer. Many online merchants who sell these goods and services may be willing to pay a fee for targeted ad placements.

In addition to providing content information associated with URIs stored in the inventive system's data store, the inventive system can also provide additional information to the user based upon the parameters of the detected URI. In an embodiment, the inventive system may analyze the URI and determine that the user is using a search engine website. Since search engine websites provide parameter data when searching, the system can then analyze the provided parameter data and determine what the user is looking for. The system may determine that the parameter data might correspond to certain goods or services. The inventive system can then provide the user with information regarding the goods or services that the user might be searching for. For example, the access program may detect the URI,

seachengine.com/search?hl=en&q=best+sat+study+program.

In this example, the base URI is “seachengine.com/search” and the search parameters are

hl=en&q=best+sat+study+program

The system can recognize that the base URI references a search engine. The inventive system may interpret the parameter information “q=” as preceding the search terms which in this example are “best”, “SAT”, “study” and “program”. By analyzing the search terms, the inventive system may then determine that the user is looking for information related to SAT study programs. In response to the search terms, the system may provide information on SAT study programs.

In other embodiments, the inventive system can look at the actual content of the website associated with the URI detected by the access program to determine what the user is interested in. For example, if the user inputs a URI associated with an electric car manufacturer, the user may be interested in low carbon emissions vehicles. In many situations, the subject matter of a website cannot be determined solely by the URI and without looking at the content of its webpages. In this embodiment, when the access program detects a URI, the inventive system can independently go to the corresponding website and analyze its content in an attempt to determine what the user is interested in. The website content analysis can be performed based upon keywords or other website metadata, text information, non-text information, or other available data. The system may then store information about the website obtained through the analysis process in the data store. Based upon the content of the website, the inventive system can provide related information to the user on the fly, and/or by searching the data store for information about the detected subject matter, and/or by providing ads for related products, and/or by other means. The subject matter of the website can be obtained by automated machine analysis of that website's data, or by accessing a previously stored analysis. An automated machine analysis of a website can be very fast, so even if the analysis, search and content data are obtained on the fly, the system response will appear to be relatively instantaneous to the user.

The inventive system may search for related content information heirarchically so that information most closely related will be searched first. If this closely related information does not exist or is not deemed relevant, the system may then search for information that is in a broader category that is less directly related. For example, if the inventive system detects that the user is looking at a website for electric cars, it can search the content data store for information regarding electric cars. If electric car content is not available in the data store, the server may search a broader category such as clean transportation. If content for clean transportation is not available, the server may search a broader category such as green environmental matters. In response to the analysis, the system may find the most relevant available information and provide this content information to the user through the access program.

For some URIs the inventive system may not yet have any associated content data. When the server searches for relevant data and none is found, the server may analyze the URI website and its content and perform a search of the data store for related information. The system may transmit the related information and/or also transmit a message indicating that exact content data associated with the URL does not currently exists on the system data store. The inventive system may also ask the user to post some content for the URI.

In yet another embodiment, the server may attempt to obtain relevant content data associated with a URI from another source. As discussed, there are third party content websites that have information about various goods and services. In an embodiment, the inventive system can search these third party websites for relevant data. The server can then provide this third party information to the access program. This use of a third party content information should only be performed with permission from the owners of the content information.

The relevant content data for a URI (that is, the data which is returned by the server to the requesting computer) might include information such as advertisements in addition to any other content data. For example, if the system detects that the URI is for a specific type of restaurant that is located in a specific area, the system may transmit advertisements for other restaurants that are similar in type or location. This information would provide users with alternative choices, for example if the restaurant of interest was fully booked or closed at the time the user was interested in eating.

In an embodiment, the inventive system can be configured to associate advertiser messages with the content data associated with specific URIs or websites. The advertiser(s) can arrange with the inventive system's management to gain access to a portion of the access window(s) when that window is displaying content associated with one or more specific URIs. This will cause the access window to display the advertisements when a specific website that has been targeted by the advertiser is simultaneously being displayed in the web browser. The advertisements may originate from the website's own management or from an entity that is not related to them such as a competitor. While it can be desirable to buy advertisements displayed in the access window that will appear when a web browser is at a company's own URI, in a free market, it can also be possible to sell the advertisement space in the access window to a competitor.

In another embodiment, advertisements can be displayed based upon the type of product offered by a web site, or based upon the location of a store that is associated with a web site. If the system detects that the URI is for the website of a specific type of business, or that is located in a specific area, the inventive system may transmit advertisements or other content to the access program for other businesses that are similar in type or location to the business displayed in the browser window. The advertisements or other content can take the form of text, pictures, video, animation, hypertext links, audio, or any other kind of content that can be found on the internet.

In an embodiment, the system can detect the volume of information and the number of posts it has available in relation to a given URI. The inventive system may then arrange the available content within the access window to efficiently occupy the available space. The system may organize the content associated with the URI so that the content, comments and ad(s) are optimally arranged within the access program window. Alternatively, the access window can include a scroll bar that allows the user to move the viewable section so that all of the content can be accessed.

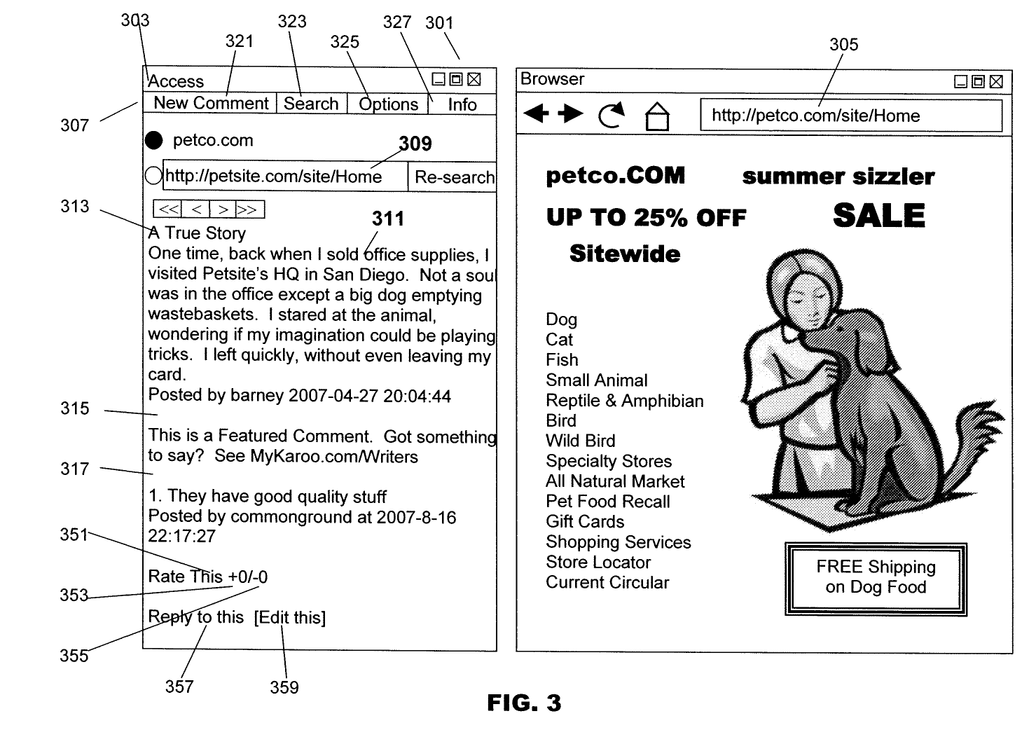

With reference to FIG. 3, an example of a client computer display 301 is illustrated. The display 301 includes a web browser window 303 and an access program window 305. The access program window 305 includes a menu bar 307, a URI definition section 309 and a system-supplied “sponsored comment” section 311. When the access program detects the URI, (in this example petco.com), the inventive system obtains, provides, and displays the related content data for that URI. In this example, the displayed data includes one “sponsored comment” entitled “A True Story” 313. The system also indicates that “barney” posted this “sponsored comment” as well as the date and time of the posting 315. While the system-supplied “sponsored comment” and the user-supplied content 317 are preferably related to the URI (in this example petco.com), there may not be any posting relevance requirements.

In an embodiment, the menu bar 307 includes a “New Comment” button 321, a “Search” button 323, an “Options” button 325 and an “Info” button 327. The “New Comment” button can allow the user to provide new content. The “Search” button 323 can allow the user to search through previously posted content, “sponsored comments”, advertisements, and possibly other data available to the invention's embodiment. An “Options” button 325 can allow the user to select configuration options, display options, etc. An “Info” button 327 can provide assistance in using the inventive system and other information to users.

In an embodiment, the inventive system also includes a community rating system for each post of content. The “rate this” button 351 provides information on how to rate the post to which the button is associated, and the ratings themselves 353 and 355 provide the overall community rating for this post. In this figure, the post has a positive (“thumbs up”) rating of 0 and a negative (“thumbs down”) rating also of 0. Other posts might have high positive ratings, high negative ratings, or both. Ratings offer a way for readers of a post to comment on the value of that post, giving other readers a measurement of that post's credibility.

In an embodiment, each post also includes a “Reply to this” button 357, allowing others to associate their own newly posted reply with this existing post. Each post may also include an “edit this” button 359 which is only visible to the user who originally submitted that particular post. In this embodiment, that user, and no other, is allowed to edit and update the given post.

Throughout the description of the inventive system, the term “button” is used to designate any actuation or control mechanism. It is intended that the interpretation of “button” be understood to include any kind of user interface element that can be used to actuate the system controls.

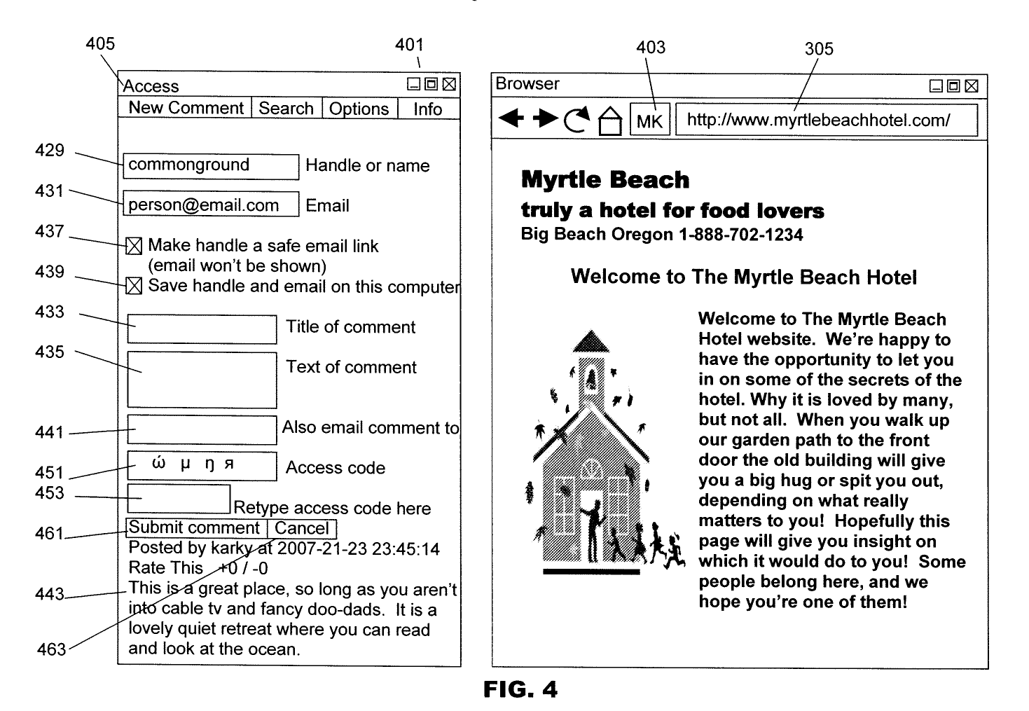

With reference to FIG. 4, a client computer display 401 is shown with the inventive system's access program window 405 after the user has pressed the “new comment” button 321 (shown in FIG. 3). A web browser window 403 is also shown. In this example, the system provides the user with input fields, including the user's handle or name 429, e-mail address 431, title of the content to be submitted 433, and the actual content to be submitted 435, which can be text, or links or other internet encoding (such as HTML or HTML-like content) that references audio, video, graphic images, or any other type of resource that might be found on the internet.

The user has the option of making the handle an anonymous safe e-mail link 437. The system can also save the handle and e-mail address so that this information is automatically provided whenever the user wishes to post content 439. The content can also be e-mailed to any address(es) input by the user 441. The posted content can be made in general or in response to previously posted materials. In this example, the user is posting a reply in response to another comment 443.

The posted content can be displayed by the inventive system in a “threaded” format, so that related posts can be viewed in a logical sequence. This organizes the posts in a useful manner so that other users can easily understand their context and respond to specific posts. Alternatively, the posted content can be unthreaded and simply displayed in the order that they were posted or received. The content can be posted for others to view in near real time so that a dialog can occur between users who wish to communicate, perhaps on a subject associated with the displayed website 403. In an embodiment, the inventive system's window may have a “chat room” feature that allows near real time communications in one portion of the invention's window, while displaying the posted data in another area.

In other embodiments, the system allows users to communicate through video (possibly including videoconferencing) or audio (such as VOIP or voice over internet protocol) by actuating corresponding controls that may be available on the access program's window. In an embodiment, these communications can be saved for review at a later time by the communicating parties, or other viewers. These communications could also be saved temporarily and deleted at the end of the communications session.

The inventive system also allows users to post content data such as copies of or links to photos, images, video, audio, and/or any other content that might be found on the internet. Visual information in images and video can provide useful information to system users. For example, a user can post a useful method for operating an apparatus described on a website. When the user goes to the apparatus website, the access window can display the posted data including the visual information that more thoroughly describes the method for operating the apparatus. In an embodiment, the images or other information can be stored on an image server through a service, as well as possibly being stored on a server or servers managed by the invention itself. Thus, when requested, the system obtains the referenced information and integrates the information into the content data transmitted to the client computers.

The inventive system may also include a security mechanism, such as a CAPTCHA mechanism, that prevents automated posting such as spam. In this embodiment, an access code having a plurality of letters and/or numbers is displayed in a field that includes a background pattern 451 which makes it difficult for a machine to identify the figures. The user must type in the correct access code characters into the access code area 453 before the new content can be posted. The proper inputting of the access code is a strong indication that the user is a human rather than a machine. With the access code in place, the user can select the “submit comment” button 461 to post the content. Alternatively, if the user decides not to post the new content, the user can press the “cancel” button 463 to go back to the main window.

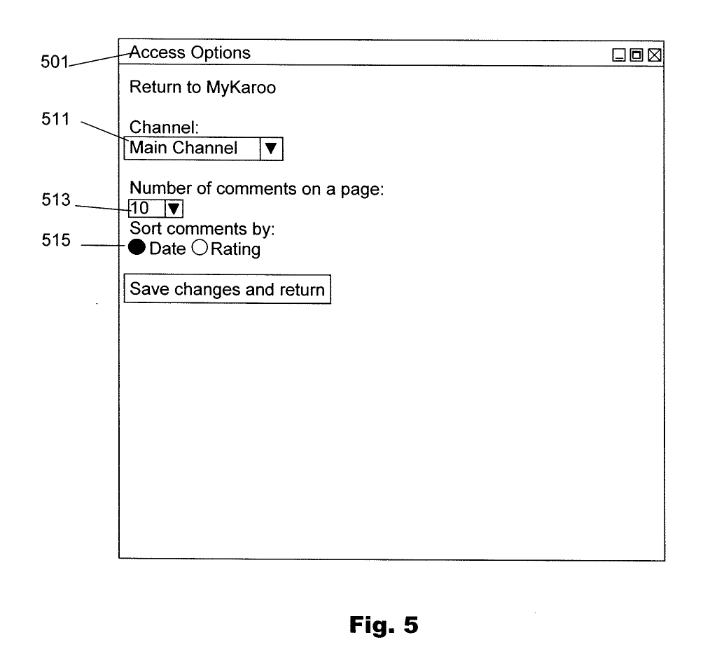

With reference to FIG. 5, if the options button 325 is selected from the menu bar the system can present the user with an options screen 501 that offers options for the operation of the access program. Some of these options might be Channel, Number of comments on a page, or comment sort order.

As discussed, there can be a plurality of different channels that are each associated with a subset of the cumulative content stored on the content data store. The user can select a desired channel through a channel control 511 to set the displayed or default content for the access program. The channels can be directed towards specific classes of users of the system, or can be segmented in some other way. Examples of possible channels include: Main, Food And Beverage, Green Building, Over Fifty, Santa Rosa, and Private Channels. The Main Channel may include normal posts from normal users. The Food And Beverage channel may target users who are interested in food and wish to view or post content with a focus on food. The Green Building channel may focus on environmental opinions. The Over Fifty channel can be used by older users and focus on issues that may be relevant to this age group. Some channels may be directed towards certain geographic regions. For example, the Santa Rosa channel may be used by people who live in or have an interest in this city.

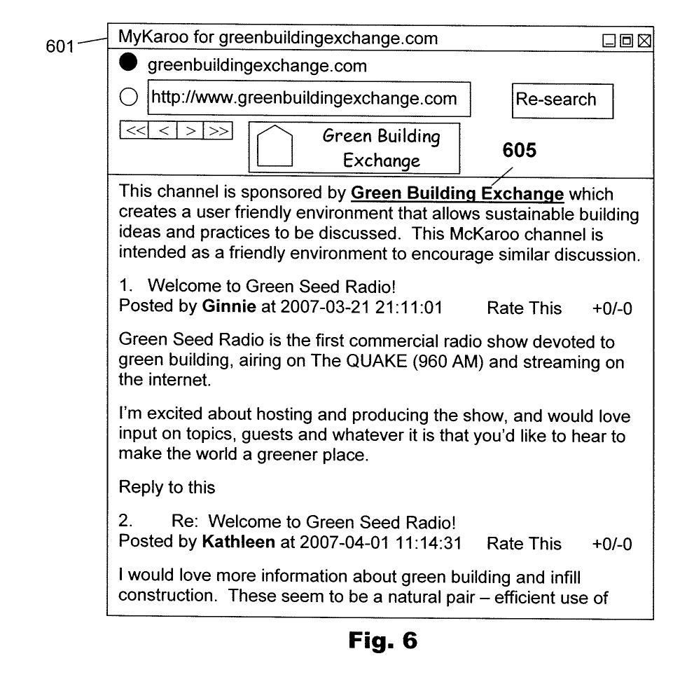

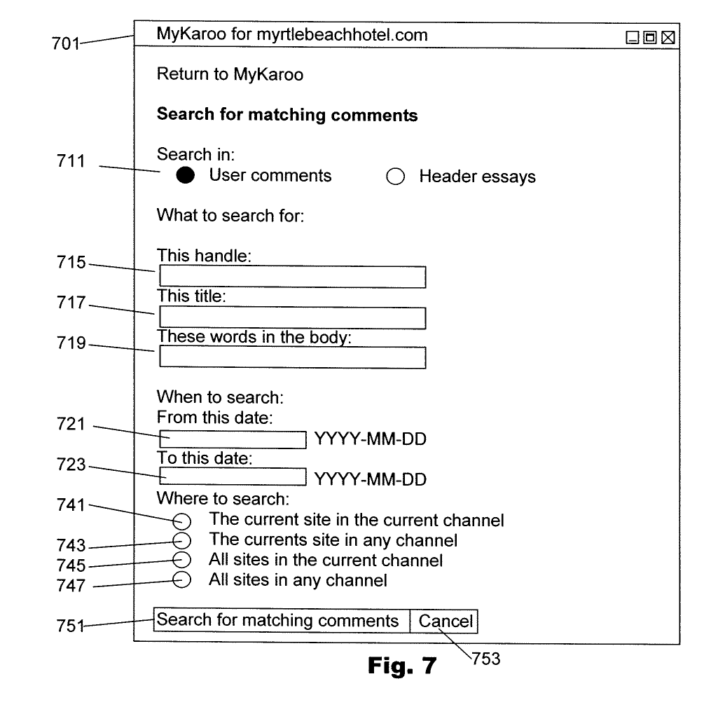

While the above-described channels may be accessible to everyone, an embodiment of the inventive system can also have private channels that can be set up for users who want their posted content available only with restricted access that requires a password (or other form of confirmation, such as biometric authentication). These private channels may allow for confidential communications among a distinct group of users and may be useful in a number of circumstances such as exchanging confidential health or financial information. The private channel mechanism can also be used for a limited group of users. For example, if the private channel users are playing a game through the website, the inventive system would allow for private communications between the players. While some online games have player-to-player communications features, many do not. In other embodiments, a channel may facilitate audio communications such as VOIP (voice over internet protocol) so the users can communicate verbally with each other. As discussed, this is different than existing communications systems which require a modified URI and transmit all webpage information through the communications website. In contrast, the inventive system does not alter the URI or the website in any way, or route it through any third party website (a practice which could raise security issues). Only content data and communications between users is provided by the inventive system. Various other types of channels are possible that might accommodate special user needs. For example, a visually impaired channel may include extra large text, or audio information. In other embodiments, some available channels can be sponsored. FIG. 6 illustrates a window of the inventive system displaying a sponsored channel 601. The sponsor of the channel can have a message which is displayed at the top of the window 605. In addition, the sponsored channel may include advertisements or special offers to viewers. These sponsored channels may be designated so that users are aware of the sponsorship. Because a substantial amount of information can exist in the data store, a system for filtering information is necessary. One possible method for obtaining focused content is targeted searching. With reference to FIG. 7, if the user selects the search button 323 in the menu bar, the system can change the window to display a search screen 701 that provides tools for searching through all of the content stored in the inventive system's data store. The search screen 701 can include different search fields which allow the user to target the search for posted content having specific text. In an embodiment, the system allows the user to search for text in specific types of fields such as the “user comments”, or within the “header essays” that are posted at the top of the window's data display 711. The user can also narrow the search within the specified content area by entering text into one or more of the fields of the search screen of the access program window. Possible search fields include the posting person's name or handle 715, title of the post 717 or words in the body of the posts 719. In an embodiment, the user can also search for content within a specific time frame after a first date 721 and/or before a second date 723.

The system can also search through subsets of the cumulative content in the data store. As discussed above, the inventive system can have different “channels” which may be thought of as different subsets of the cumulative data associated with each URI. Each channel's focus might be towards a different group of users. The user can browse and search through the content of the different channels to see posts and conversations that are posted and viewed by different groups using text or other search methods. In some embodiments, certain channels may be designated as “private channels” and require a user to have special identification or authorization to browse and search the content posted on a private channel. The search system can provide various channel search options. For example, the system can allow the user to search the channel and URI currently being viewed by the user 741, the URI currently being viewed by the user in all channels 743, all URIs for the channel currently being viewed 745 or all channels in all URIs 747.

Once the user has selected the search criteria, the search button 751 is pressed and the system searches the data store for content the matches the search criteria. The system will then extract the matching content from the data store to provide a listing of the matching content. The user may alter the search criteria and repeat the search process to improve the accuracy of the search results or for other reasons. If the user wishes to cancel the search, the cancel button 753 can be pressed and the user can return to the main access program window.

With reference back to FIG. 5, various other access program window controls are available to the user. The “number of comments on a page” control 513 provides the user with options to display different numbers of posts per page. The user can select the desired number per page, such as 10, 15, 25, 50, etc. Additional pages of content may be accessed by selecting one of the navigation buttons, such as next 371, previous 373, first page 371, and last page 375, as shown on FIG. 3. The system may also provide other methods for controlling the displayed postings. For example, the content that is displayed can be limited by time, so that only one day, month or year's worth of content is displayed on each page, with other pages accessed by using the navigation buttons described above. The user can also control the order in which the content is displayed. For example, the content can be displayed by date, with the oldest or newest content displayed first and the remaining content organized in a chronological manner.

In an embodiment, the inventive system can have a rating feature that allows the user to rate the content. These ratings can be tabulated resulting in a score based upon the cumulative rating, or average user rating, or some other means. When content is obtained by an access program, the user can then choose to have the content displayed sorted by user rating 515, with the highest or lowest rated content displayed first and the remaining content organized by ascending or descending ratings. In other embodiments, the system can control many other display options including color, font, text size, theme for the display, display location, content filters for younger users, or other options.

In an embodiment, the inventive system has user-accessible controls that customize the operation, including the functionality and appearance of the inventive system. The functional controls can selectively actuate the inventive system's access window based upon the user's preference. The system can be set to automatically display a window for all URIs or provide a button in the browser menu or tool bar or elsewhere that only displays the access window when actuated. The system may also be able to detect certain URIs associated with specific websites for which the user does not wish to have the inventive system's access program window displayed. This feature allows the user to close the system's access program window when these websites are requested, perhaps so that space on the monitor is not consumed during these tasks, or the user is not distracted by the access window, or for other reasons. The access program may have a look up table that allows the user to specify the preferred access program operation when specific URIs are detected. Thus, before displaying the access window, the system may include the step of referencing the look up table to determine if the access window should or should not be displayed.

In other embodiments, the position and size of the access program window can be controlled in various ways. In the preferred embodiment, the access program window will occupy a somewhat smaller portion of the display than the web browser window. The user can place the access program its window at any area of the display while reducing the size of the web browser display so that both the browser and content windows fit within the available space. For example, the access program window can be placed on the left side and the web browser in the center and right sides of the display. Once the desired display options are selected, the user can save the changes and return to the system's main window by clicking on the “save changes and return” button 617.

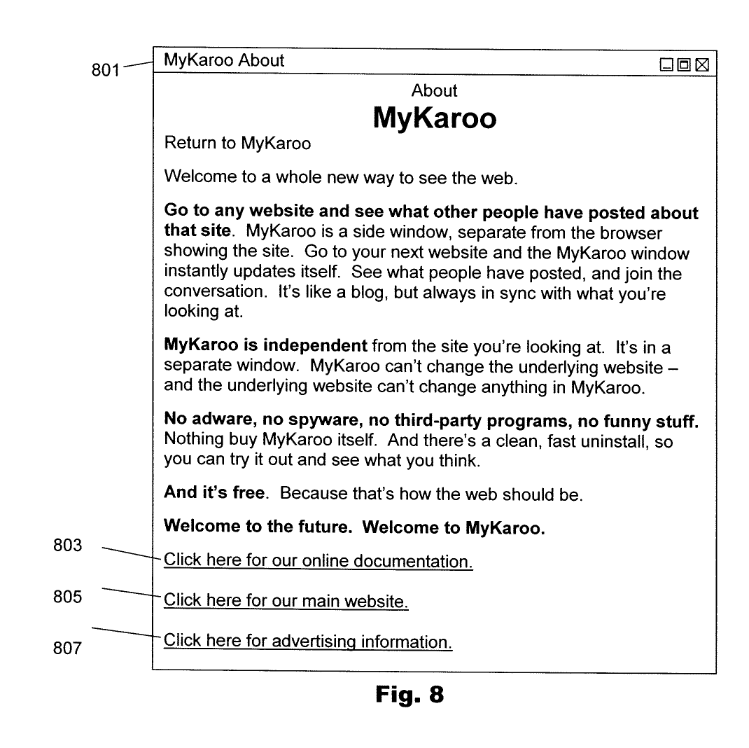

With reference to FIG. 8, clicking on the information button 327 can result in the display of additional information about the inventive system 801. The information thus displayed can provide links to additional information including documentation such as operating instructions 803, a link to the inventive system's own website 805, advertising information 807, etc.

As discussed above, before content data is displayed by the access program on a client computer, it must be properly formatted. The required data format will depend upon the device on which it will be displayed. For example, devices that have small screens, such as wireless phones, may require a different display format than devices which have larger screens, such as desktop or laptop computers. Similarly, as technology evolves, it may be necessary to provide information in a currently unknown format or formats. In an embodiment, the access program will obtain and send format-specification information to the server so the data can be properly formatted. In another embodiment, the server will store formatting information in the data store. This information may be gathered during a registration process, through an automated test that is performed by the access program on the client computer, or by other means. Once the proper format information is obtained, the server can automatically transmit the data in the proper format based upon the information stored for the specific access program and computer.

It is well known that a user's actions in the web browser may result in the display of pop up ads. In an embodiment, the access program can detect and respond to pop up ads by displaying a window (which may be the inventive system's currently-open access program window) that includes information or opinion regarding the advertiser, the product or service referenced by the pop up ad, or other relevant information. The window may also provide information that includes instructions or a control (such as a button) for removing this ad or all similar ads, or one or more controls for automatic removal or deactivation of such ads. When the ad is removed or closed, the system's window associated with the ad may also automatically close or revert back to the content relating to another URI, such as the URI for the website that is currently active in the web browser. The access program may have special controls that allow the user to customize the response to pop up ads.

In addition to controlling the access window display, the inventive system can also control the way that the content information is transmitted to the client computers. In a first optional setting the system might display any stored data automatically as soon as the inventive system's server provides it to the client computer. Alternatively, the access program might cache the content until it is requested by the inventive system on behalf of the user. In this embodiment, when the data is requested, the access program will immediately display it.

In an alternative embodiment, the access program may not request such content from the server until the user activates a control. With reference to FIG. 3, a browser tool bar 353 includes a content display button 351. This button 351 may toggle between display modes and allow the user to see either the access program's window 305 with the browser window 303, or only the browser window 303. In an embodiment, when the user clicks on the display button 351 to see both windows, the access program can resize the browser window 303 to make room for the inventive system's window 305. When the window 305 is hidden, the access program may resize the browser window 303 to occupy a larger portion of the display. Various other display options are also possible.

In an embodiment, the posted content information is not screened by the inventive system. Thus, content can be provided either by parties associated with the website to which the content refers, or by parties not associated with the website to which the content refers. This can be problematic if biased content is posted, such as by users associated with the subject website. However, as more people post content, the influence of biased posts will decrease. Further, in an embodiment each post can be rated up or down by others who read that post, and biased posts will inevitably be rated down by the community of readers, indicating to readers that the community as a whole gives less credence to such posts. A potential problem with freely posted user-supplied content is that there is a potential for posting inappropriate content such as spam. There are several methods available to deal with this problem. In an embodiment, if a post becomes poorly-enough rated it is no longer displayed. This becomes a mechanism by which the community itself can remove inappropriate posts such as spam, with no intervention required by personnel associated with the inventive system. In another embodiment, the inventive system may have an automated or non-automated content searching capability to flag posted content for review by the management of the inventive system or its designees. Another screening method is peer review, in which the users of the system can flag content that is perceived as inappropriate. The system can have controls that expose flagged content to closer scrutiny from a broader group of users so that only content that meets a certain standard of quality and accuracy will remain in the set of available data. In order to avoid spam, the database may have a feature that detects if the same posting has been posted on the system's pages relating to multiple websites. The flagging may result in the removal or review by users or by a system manager, or may result in some other action.

In an embodiment, the inventive system can also include a mechanism for removing or hiding old content postings. The mechanism may simply delete postings after a preset period of time, or they can be archived but not displayed. The cutoff time may be related to the type of product, the popularity of the URI, peer ranking of the content, and/or some other factor or factors. This can be useful because content for an old product such as movie reviews may remain relevant for many years. In contrast, some products are constantly changing such as lottery ticket results and any related content may not be useful information after a period of time.

With reference to FIG. 9, the inventive system has been described herein as including a server 961 and data store 969 that provide content to a plurality of client computers 963. In other embodiments, the inventive system can provide the content in a peer-to-peer configuration as shown in FIG. 10, instead of a client/server configuration as shown in FIG. 9. In this embodiment, each peer computer 965 and 967 functions as both a client and a server with data relating to each URI stored on one or more of the data stores 969 that are accessible to the peer computers 965 and 967. When content data is requested by one of the peer computers 967, the inventive system on each of the peer computers 965 and 967 can search its own data store and transmit the relevant data back to the requesting peer computer 967. The access program on the requesting peer computer 967 can then aggregate the received data and display this information in its window.

In other peer to peer embodiments, each peer computer can have a data store of URI-related content. A request is transmitted by the requesting computer to access the content data stored on each of the other peer computers. In one possible embodiment, this information would be separated from the rest of the data on the peer computers, perhaps for reasons of security. When content for a URI is required, the system would search all available peer computers' content data for relevant content. When relevant content data is found, it would be routed back to the requesting peer computer. If a plurality of the peer computers provide associated content data, the requesting computer may aggregate this information based upon date of creation, relevance, and/or one or more other factors. The inventive system may also remove any duplicate content that was transmitted from multiple computers.

In an embodiment, content can be created using a tool or tools provided by a third party. These tools may search for, aggregate, and post information to the inventive system. It can also be possible to obtain content from a website provided by the inventive system's management, or some other cooperating website, or to use such a website to input data to the system. The user can use such a website to search for and view content of interest and input new content to the system. Such content would be archived in the system's data store as described above.

In an embodiment, while the sharing of content information can be mutually beneficial to the operators of websites unrelated to the inventive system, the use of unauthorized content published by others can be problematic. Where information is used by the inventive system that is protected by intellectual property rights such as copyright, the content provider for the inventive system should always secure permission to use such information prior to providing the content information in any unauthorized or illegal manner.

In an embodiment, the access program used by the client computers is an “add in” program that works with a browser program provided by other means. While the preferred embodiment of the access program is a Netscape/Mozilla family Plug-in or a Microsoft Internet Explorer family Browser Helper Object, other configurations are possible. For example, the access program functionality that has been described herein could be implemented as part of the web browser itself. The access program may be implemented as one executable program, or a suite of executable programs, or one or more browser extensions not directly executable, or a combination of these.

As discussed above, three primary logical components of the inventive system include: server, data store and access program running on client computers. In various embodiments the server component can be implemented using different mechanisms. It can be an independent program running on a general-purpose computer, or a standalone hardware device(s). In the preferred embodiment, the server is coupled to the client computer(s) via a network such as the internet, intranet, LAN, WAN, bus, interprocess communication, etc. In the preferred embodiment, the data store can be implemented to use one or more storage devices such as hard drives, however it may also use any data storage device including RAM, ROM, etc. Any mechanism that is a persistent searchable data store can be configured as the inventive system's data store. If used in the described manner any of these memory devices will fall within the intended meaning of the “data store ” claim term. Similarly, “client computer” can be a traditional desktop or notebook computer or various other computing devices such as mobile phones, personal digital assistants and any other known or unknown electronic devices that include the capacity to run the inventive system. The term “computer” is intended to include hardware and software normally used in a computer system including: microprocessors, memory, display screens or monitors, keyboards, mice and operating system software, or any successor or similar or related classes of devices.

While these components have been described as separate and distinct physical or logical components, they can be located in very close proximity to each other or even within the same structural device or software component. For example, the inventive system may have one or more of its logical components (designated here as server, data store, and access program) all running on a single computer, all running on separate computers (and communicating remotely), or any combination. In another example, the access program may be implemented to also include the functionality ascribed herein to the server, that is, with these two logical components implemented as a single software component or program. In another example, the data store may be implemented as part of the server component (which, as above, may be part of the access program component).

In another example, the data store may be accessible to multiple servers, or just one server. If just one server, the access program may provide content data to a single user for each URI. This would be particularly useful for users who might wish to store personal information such as login data, passwords and user names for different URI websites. When the system detects that a user is at a website, the system displays the stored content data associated with that website. In this embodiment, the server is a portion of the local computing capacity, the data store is the computer's memory or other local data store, the access program is that logical component that interacts with the web browser and the user, and the client computer is that logically distinct portion of the local computing capacity that not being used as any component referenced above. Thus, as long as there is a logical distinction between the server, data store and client computer, these components can be arranged in any physical manner relative to each other.

It will be understood that the inventive system has been described with reference to particular embodiments, however additions, deletions and changes could be made to these embodiments without departing from the scope of the inventive system. Although a system has been described that includes various components, it is well understood that these components and the described configuration can be modified and rearranged in various other configurations.

What is claimed is:

1. A method for providing content data associated with a webpage comprising:
providing a data store that is searchable by a server program, the data store having content data associated with a uniform resource identifier (URI) for the webpage;
providing at least one client computer having a web browser program and an access program, wherein the access program detects the URI input into the web browser program;
transmitting the URI detected by the access program to the server program;
searching the data store by the server program for content data associated with the URI;
transmitting by the server program the content data associated with the URI from the data store to the access program on the client computer; and
displaying by the access program the content data associated with the URI.

2. The method of claim 1 further comprising:
transmitting a second URI detected by the access program to the server program;
searching the data store by the server program for content data associated with the second URI;
transmitting by the server program the content data associated with the second URI from the data store to the access program on the client computer; and
displaying by the access program the content data associated with the second URI.

3. The method of claim 2,
wherein the content data associated with the second URI replaces the content data associated with the first URI displayed by the access program.

4. The method of claim 2, wherein the content data associated with the second URI is displayed by the access program in addition to the content data associated with the first URI.

5. The method of claim 1 further comprising:
displaying by the access program the content data in a separate window adjacent to a window displayed by the web browser program.

6. The method of claim 1 further comprising:
displaying by the access program the content data within a window displayed by the web browser program.

7. The method of claim 1 further comprising:
inputting new content data to be associated with the URI;
transmitting by the access program the new content data to the server program; and
storing by the server program in the data store the new content data associated with the URI.

8. The method of claim 1, wherein the access program is on the same computer as the server program.

9. The method of claim 1, wherein the access program is on a different computer than the server program.

10. The method of claim 1, wherein the server program is on the same computer as the data store.

11. The method of claim 1, wherein the server program is on a different computer than the data store.

12. A method for providing content data associated with a webpage comprising:
providing a data store having content data associated with a uniform resource identifier (URI) for the webpage;
providing at least one client computer having a web browser program and an access program;
detecting by the access program the URI input into the web browser program;
searching the data store by the access program for content data associated with the URI; and
displaying by the access program the content data associated with the URI.

13. The method of claim 12 further comprising:
detecting a second URI by the access program input into the web browser program;
searching the data store by the access program for content data associated with the second URI; and
displaying by the access program the content data associated with the second URI.

14. The method of claim 13, wherein the content data associated with the second URI replaces the content data associated with the first URI displayed by the access program.

15. The method of claim 13, wherein the content data associated with the second URI is displayed by the access program in addition to the content data associated with the first URI.

16. The method of claim 12 further comprising:
displaying by the access program the content data in a separate window adjacent to a window displayed by the web browser program.

17. The method of claim 12 further comprising:
displaying by the access program the content data within a window displayed by the web browser program.

18. The method of claim 12 further comprising:
inputting new content data to be associated with the URI; and
storing by the access program in the data store the new content data associated with the URI.

19. The method of claim 12, wherein the access program is on the same computer as the data store.

20. The method of claim 12, wherein the access program is on a different computer than the data store.
